(19) United States
(12) Patent Application Publication
(10) Pub. No.: US 2013/0307238 A1
(43) Pub. Date: Nov. 21, 2013

(54) CARTS

(71) Applicants: Glen Craig Campbell, Dunedin Central (NZ); Wayne George Scott, Saint Clair (NZ)

(72) Inventors: Glen Craig Campbell, Dunedin Central (NZ); Wayne George Scott, Saint Clair (NZ)

(21) Appl. No.: 13/885,128

(22) PCT Filed: Nov. 11, 2011
(86) PCT No.: PCT/NZ11/00239

§ 371 Date: Jul. 31, 2013

Related U.S. Application Data
(60) Provisional application No. 61/412,581, filed on Nov. 11, 2010.

(30) Foreign Application Priority Data
Nov. 11, 2010 (NZ) 589194

(51) Int. Cl. B62B 3/02

(52) U.S. Cl. CPC B62B 3/02
USPC 280/35

(57) ABSTRACT

A modular cart unit including a plurality of interconnected modules, the modular cart having:

at least one module including a wheel assembly;

at least one further module;

at least one handle portion configured to releasably attach to the at least one module including a wheel assembly and/or the at least one further module; and the at least one module including a wheel assembly and/or at least one further module is/are adapted to releasably interconnect to one or more additional modules, and wherein the interconnection between modules forms a rigid body of the cart and wherein at least one additional module is fully supported by two adjacent modules.

### STATEMENT OF CORRESPONDING APPLICATIONS

This application is based on the Provisional specification filed in relation to New Zealand Patent Application Number 589194, the entire contents of which are incorporated herein by reference.

### TECHNICAL FIELD

The present invention relates to improvements in and relating to carts. In particular, the present invention relates to modular carts used for transportation of tools, materials and equipment required to be transported together for some common purpose.

### BACKGROUND ART

Successful commercial cleaning enterprises require efficient use of a cleaner's time in order to achieve a good profit margin. One tool that is commonly used by cleaners to improve their efficiency is a cleaning or service trolley. A cleaning/service trolley keeps the most commonly used tools, materials and equipment (TME) at hand.

Most cleaning/service trolleys used in commercial cleaning operations are large and rudimentary in nature. Typically a commercial cleaning service trolley needs to carry, as a minimum, at least one mop and bucket, linen, toilet and bathroom supplies, linen and dirty linen sacks, and trash sacks. Carrying such a large assortment of equipment means cleaning trolleys are not easily transportable and typically remain on site. This requires cleaners who have more than one cleaning contract or cleaning job to have separate trolleys at each location.

The benefit of such cleaning/service trolleys is also one of their disadvantages, that being that for routine work the cleaner is required to cart all of the extra tools, materials and equipment with them.

Another disadvantage of cleaning/service trolleys is that they are not scalable. What may have been the right choice of cleaning/service trolley for a small scale cleaning operation quickly becomes redundant when further cleaning tasks are added to the original routine. Equally, the disadvantage of reduced mobility would mean a large cleaning/service trolley would be inefficient for the original small scale operation.

It would therefore be useful to provide a cleaning/service trolley that was capable of being adapted to allow efficient use for both small and large scale cleaning operations as well as being both highly modular and portable.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

It is an object of the present invention to address the foregoing problems or at least to provide the public with a useful choice.

Further aspects and advantages of the present invention will become apparent from the ensuing description which is given by way of example only.

### DISCLOSURE OF THE INVENTION

According to one aspect of the present invention there is provided a modular cart unit comprising a plurality of interconnected modules, the modular cart including:
at least one module including a wheel assembly;
at least one further module; and
at least one handle portion configured to releasably attach to the at least one module including a wheel assembly and/or the at least one further module,
   characterised in that the at least one module including a wheel assembly and/or at least one further module is/are adapted to releasably interconnect to one or more additional modules, and/or one or more additional modular cart units and wherein the interconnection between modules/modular cart units is structural.

As used herein the term ‘module’ refers to a modular cart, or part therefor. The term ‘module’ may include, but should not be limited to, one or more of the following:
handle(s);
tray(s);
container(s).

A modular cart unit should be understood to describe any service trolley that comprises a further module which is able to be releasably attached to one or more additional modules.

Preferably the wheel assembly includes at least one wheel or roller or the like.

The wheel assembly may be attached to the further module or may form part of the further module.

In preferred embodiments the wheel assembly includes at least two wheels or the like located at one end of the modular cart unit so as to enable tilting of the modular cart unit between a mobile position and a stationary position.

The further module may come in a variety of different forms without departing from the scope of the present invention.

In some preferred embodiments the further module may include at least one container. It will be apparent to a person skilled in the art that a container could take any number of shapes without departing from the scope of the present invention, a non-limiting list including open top buckets, lidded buckets, trash receptacles, tool boxes or the like.

In preferred embodiments the further module is a case which includes a lockable hinged lid.

In some preferred embodiments the lid or part thereof may be transparent.

In alternative preferred embodiments the further module may comprise a frame or structural member. The frame or structural member including a wheel assembly and being adapted to support or be connected to a container.

In some preferred embodiments the further module forms a structural member in the form of a chassis to which one or more containers may attach. Attachment may be by way of quick fit clips, quick release clamps or simply gravity holding the attachment upon the frame.

In preferred embodiments the handle portion attaches to the further module of the modular cart unit, or part thereof.

In preferred embodiments the handle includes at least one holding portion into or onto which a bag or bin can be attached or retained.

In preferred embodiments the holding portion is capable of holding the top of a retained bag open.

In preferred embodiments the handle portion is releasably attachable to the body portion of the modular cart unit.

In preferred embodiments the handle is at least partially collapsible so as to facilitate compact storage.

In preferred embodiments the handle portion includes telescopic support members. It will be apparent to a person skilled in the art that telescopic support members may allow for adjustability of height for different operators and better collapsibility for storage purposes.

In preferred embodiments the holding portion is capable of folding in on itself so as to further aid the collapsibility of the modular cart unit for storage and transport.

In preferred embodiments the modular cart unit/module and/or module/module connection is by way of quick connect fittings which can be coupled or decoupled in a matter of seconds.

In other preferred embodiments the modular cart unit/module and/or module/module connection is by way of quick release clamps, or the like.

In especially preferred embodiments the modular cart unit/module and/or module/module connection is by way of a snap-fit locking connection between mating male and female parts.

In preferred embodiments the modular cart unit is configured to releasably connect to one or more modules at one or more of:
a front portion of a module;
a rear portion of a module;
to one or both sides a module;
to the handle.

It will be appreciated that there are a huge number of devices and methods that are capable of providing the modular cart unit/module and/or module/module connections. The exact configuration of the modular cart unit/module and/or module/module connection should therefore not be seen as being limiting.

Any number of modules may be designed to attach to the further module. The exact shape and configuration of the modules should not be seen as being limiting as these will vary depending on the end purpose of the modular cart unit. Furthermore, additional modules may be designed and added to the product range as a need for those additional modules arises. The present invention should therefore not be seen as being limited to the modules shown or described herein.

In preferred embodiments modules may include, but should not be limited to, one or more of, buckets, tubs, tool boxes, vacuum modules, compactors, receptacles, tool holders, shredders, bag holders or the like.

Each module is designed to provide convenient and efficient containment of all tools and materials. The materials catered for may include, but should not be limited to, cloths, bottles, rolls, water and liquids, rubbish, recycle bags and bag liners.

In some preferred embodiments the modules or part thereof are colour coded, for example:
Yellow—for standard waste or general cleaning tools/equipment;
Red—for organic waste or ‘dirty’ cleaning tools/equipment, i.e. floor cleaning clothes or the like;
Green—for recycling or ‘clean zone’ cleaning tools/equipment, i.e. for cleaning bench tops or kitchen areas.

Each module may be configured to provide ergonomic access to the stored tools and materials.

In preferred embodiments the additional modular cart units are configured to attach to a first modular cart unit by way of connection to:
at least one module of the first modular cart unit;
the handle of the first modular cart unit;

In preferred embodiments one or more modules includes:
an additional wheel assembly; or
at least one support or stand.

It will be apparent to a person skilled in the art that as the modular cart unit becomes encumbered with additional modules, there will come a point whereby an additional wheeled module will need to be attached. The additional wheeled module creating a stable and manoeuvrable platform.

In preferred embodiments the additional wheel assembly includes one or more castors.

In preferred embodiments the modules form a structural component of the modular cart unit when attached thereto.

In preferred embodiments the further module of the modular cart unit is capable of separating from the handle portion and the wheel assembly.

In preferred embodiments the further module of the modular cart unit may be used as a transport box.

In especially preferred embodiments the body portion of the modular cart unit is capable of storing one or more of:
the handle portion;
the wheel assembly; and/or
one or more modules.

In preferred embodiments the further module includes a lockable lid for securing the contents.

According to a further aspect of the present invention there is provided a kit of parts for a modular cart unit, the kit includes, but should not be limited to:
at least one module including a wheel assembly;
a further module; and
a handle portion configured to attach to one, or both of the at least one module including a wheel assembly and/or the body portion.
   characterised in that the at least one module including a wheel assembly and/or body portion is/are adapted to releasably connect to one or more modules, and/or one or more modular cart units and wherein interconnect ion between modules/modular cart units is structural.

In preferred embodiments the kit of parts includes one or more modules.

In preferred embodiments the further module of the modular cart unit may be used as a transport box for containing the parts that are included in the kit.

Advantages of preferred embodiments of the present invention may include, but should not be limited to:
Providing a cleaning/service trolley that may be configured/re-configured for each job a contract cleaner may face, allowing the operator to configure the trolley for manoeuvrability and/or the capacity to carry equipment and/or supplies.
Providing a cleaning/service trolley that may provide ease of dismantling and therefore convenience of transportation between clients' premises.
Providing a cleaning/service trolley which may be configured at each client's premises, depending on the job required and allowing for different tools and equipment to be carried.
Providing a cleaning/service trolley that is scalable, allowing a contractor to begin with a basic trolley having few modules whilst allowing the contractor to up-scale with additional modules as their business expands.
Providing an operator configurable/structured cleaning/service trolley, which may provide improved work efficiency through known and accessible equipment placement.

### BRIEF DESCRIPTION OF THE DRAWINGS

Further aspects of the present invention will become apparent from the following description which is given by way of example only and with reference to the accompanying drawings in which:

FIG. 1 shows an isometric view of a first modular cart unit in accordance with the present invention;

FIG. 2 shows an isometric view of a second modular cart unit in accordance with the present invention;

FIG. 3 shows an isometric view of a third modular cart unit in accordance with the present invention;

FIG. 4 shows an isometric view of a dismantled and stowed modular cart unit in accordance with the present invention;

FIG. 5 shows an exploded isometric view of the dismantled and stowed modular cart unit of FIG. 4;

FIG. 6 shows an isometric view of one preferred embodiment of the handle portion of the present invention;

FIG. 7 shows an isometric view of a fourth modular cart unit in accordance with the present invention.

### BEST MODES FOR CARRYING OUT THE INVENTION

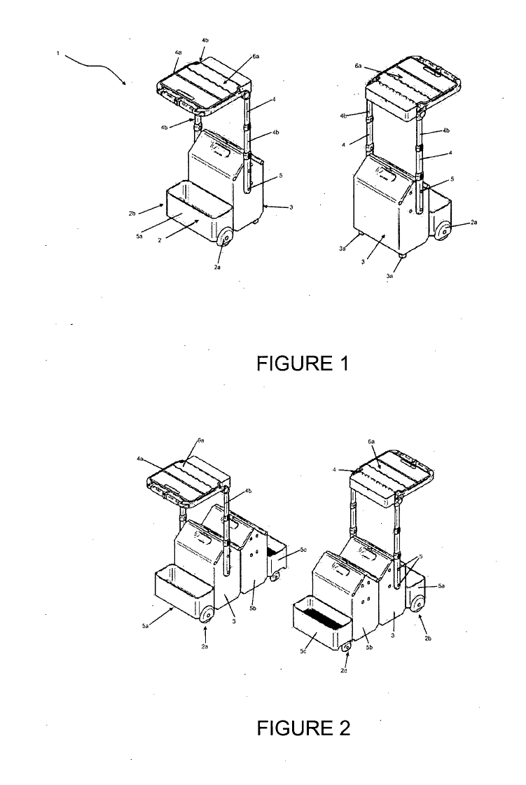

With respect to FIGS. 1-5 and 7, there is shown a modular cart unit according to one preferred embodiment of the present invention, as generally indicated by arrow 1. The modular cart unit 1 includes a wheel assembly 2 in the form of bag module 5a onto which two wheels 2a and 2b are attached, both wheels 2a, 2b are visible in FIG. 2. The modular cart unit 1 also includes a body portion in the form of toolbox 3 onto which handle portion 4 is attached. Handle portion 4 can be attached to and removed from body portion 3 by way of connectors 5. Wheel assembly 2 attaches to body portion 3 by way of releasable connectors (not visible).

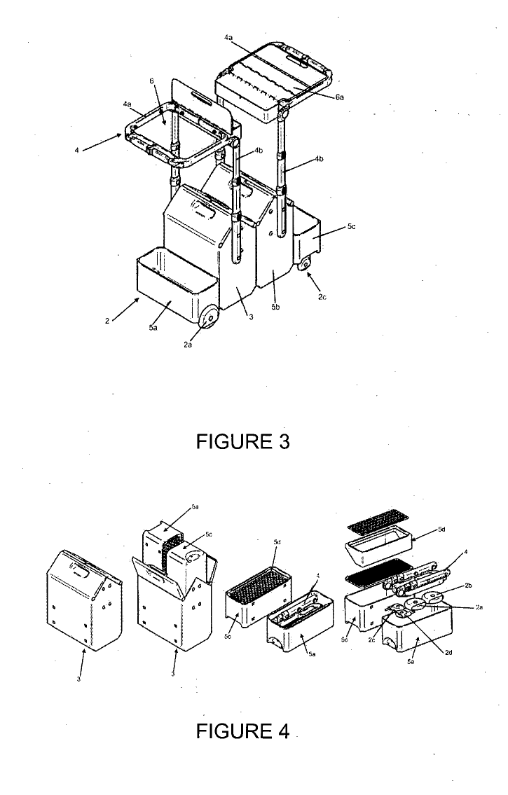

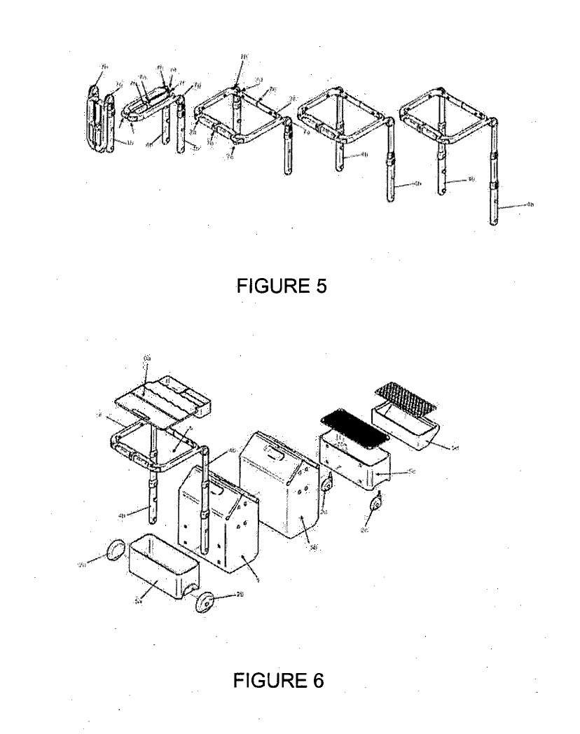

The modular cart unit 1 is adapted to connect to one or more modules, including:
bag module 5a—shown in FIGS. 2, 3, 4 and 5;
toolbox module 5b—shown in FIGS. 2, 3 and 5;
open top module 5c—shown in FIGS. 2, 3, 4 and 5;
tray module 5d—shown in FIGS. 2, 3, 4 and 5;
5e, shown in FIGS. 4 and 5.

In use the modular cart unit 1 of FIG. 1 is tilted back over the wheels 2a, 2b to facilitate mobility of the modular cart unit 1. When not held in a tilted position the modular cart unit 1 rest on wheels 2a, 2b and the front edge 3a of body portion 3, thereby resting in a stable stationary position.

Handle portion 4 includes holding portion 4a with opening 6 into or onto which a bag or bin (not shown) can be attached or retained in an open and accessible position. Alternatively a tray 6a can be attached to the holding portion 4a so as to cover opening 6 and provide a platform upon which tools (not shown) can be positioned. Handle portion 4 includes telescopic support members 4b, which allow compaction of the handles downward to allow height adjustment for the operator and improved collapsibility for storage purposes.

Handle portion 4 includes hinges 7a, 7b, 7c, 7d, 7e, 7f, 7g and 7h. Hinges 7a, 7b and 7c allow handle portion 4a to fold forward into holding portion 4. Equally, hinges 7d, 7e and 7f allow the front 4b of holding portion 4 to fold back into holding portion 4. Hinges 7h and 7g allow telescopic support members 4b to rotate back towards holding portion 4. This is most clearly shown in FIG. 6, wherein, from left to right, hinges 7g and 7h allow rotation of telescopic support members 4b to rotate away from holding portion 4 into a vertical position. Hinges 7a, 7b, 7c are simultaneously rotated with hinges 7d, 7e, 7f to rotate handle portion 4a and front 4b of holding portion 4 away from each other to form holding portion 4. Telescopic support members 4b are then extended to the correct height for a specific operator or to support a specific length container or bag.

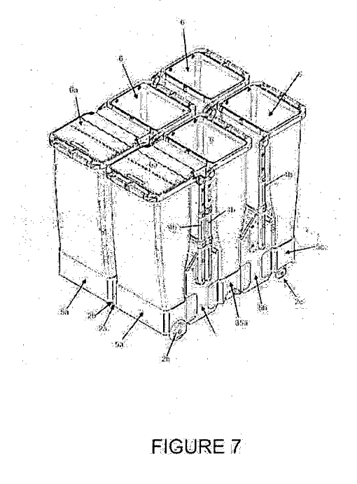

Modules are attachable to any of the front 8, the rear 9, to one or both sides of the body portion 3 or to the handle 4. This configurability is shown in FIG. 5 wherein a modular cart unit 1 is shown in modular form prior to interconnection, the modular cart unit of FIG. 5 including a body portion in the form of toolbox 3, a handle portion 4, a wheel assembly 2 in the form of bag module 5a onto which two wheels 2a and 2b are attached, a secondary toolbox 5b, an open top module 5c onto which a set of pivotable wheels 2c, 2d attach and a tray module 5d. Each of the modules interconnect to form a single structural modular cart unit 1. FIG. 7 also illustrates the configurability of the modular cart system, showing both side-by-side and end-to-end connection of cart modules.

When in modular form, the separate modules are configured to either form carrying cases or to be stowable within other modules. This is shown in FIG. 4, wherein the modular assembly of FIG. 5 is shown in a stowed state. Wheels 2a, 2b, 2c and 2d and compacted handle 4 are stowed into bag module 5a. Tray module 5d stows into open top module 5c. Both bag module 5a and tray module 5d stow into toolbox module 3. Any surplus equipment can be stowed in secondary toolbox 5b.

Aspects of the present invention have been described by way of example only and it should be appreciated that modifications and additions may be made thereto without departing from the scope thereof as defined in the appended claims.

1-26. (canceled)

27. A modular cart unit comprising a plurality of interconnected modules, the modular cart comprising:
at least one module including a wheel assembly;
at least one further module;
at least one handle portion configured to releasably attach to the at least one module including a wheel assembly and/or the at least one further module; and
the at least one module including a wheel assembly and/or at least one further module is/are adapted to releasably interconnect to one or more additional modules, and wherein the interconnection between modules forms a rigid body of the cart and wherein at least one additional module is fully supported by two adjacent modules.

28. The modular cart unit as claimed in claim 1 wherein the wheel assembly is attached to or forms part of the further module.

29. The modular cart unit as claimed in claim 1 wherein the wheel assembly includes at least two wheels located at one end of the modular cart unit so as to enable tilting of the modular cart unit.

30. The modular cart unit as claimed in claim 1 wherein the at least one module is a container.

31. The modular cart unit as claimed in claim 30 wherein the container includes a transparent lid.

32. The modular cart unit as claimed in claim 1 wherein the interconnected modules form a single structure in the form of a chassis.

33. The modular cart unit as claimed in claim 1 wherein the at least one handle portion attaches to the further module of the modular cart unit, or part thereof.

34. The modular cart unit as claimed in claim 1 wherein the handle includes at least one holding portion.

35. The modular cart unit as claimed in claim 34 wherein the holding portion is capable of holding the top of a retained bag open.

36. The modular cart unit as claimed in claim 1 wherein the handle portion is releasably attachable to the at least one module including a wheel assembly, or the at least one further module.

37. The modular cart unit as claimed in claim 1 wherein the handle is at least partially collapsible.

38. The modular cart unit as claimed in claim 1 wherein the modular cart unit/module and/or module/module are interconnected by way of one or more of:
quick connect fittings;
quick release clamp; and/or
snap-fit locking connection between mating male and female parts.

39. The modular cart unit as claimed in claim 1 wherein the modular cart unit is configured to releasably connect to one or more modules at one or more of:
a front portion of a module;
a rear portion of a module;
to one or both sides of a module;
to the handle.

40. The modular cart unit as claimed in claim 1 wherein the modules or part thereof are colour coded.

41. The modular cart unit as claimed in claim 1 wherein additional modular cart units are configured to attach to a first modular cart unit by way of connection to:
at least one module of the first modular cart unit;
the handle of the first modular cart unit;

42. The modular cart unit as claimed in claim 1 wherein one or more modules include:
an additional wheel assembly; or
at least one support or stand.

43. The modular cart unit as claimed in claim 1 wherein the modules form a structural component of the modular cart unit when attached thereto.

44. The modular cart unit as claimed in claim 1 wherein the further module of the modular cart unit is capable of separating from the handle portion and the wheel assembly.

45. The modular cart unit as claimed in claim 44 wherein the further module of the modular cart unit is used as a transport box.

46. The modular cart unit as claimed in claim 45 wherein the further module of the modular cart unit is capable of storing one or more of:
the handle portion;
the wheel assembly; and/or
one or more modules.

47. The modular cart unit as claimed in claim 1 wherein the further module includes a lockable lid for securing the contents.

48. A kit of parts for a modular cart unit, the kit comprising:
at least one module including a wheel assembly;
a further module;
a handle portion configured to attach to one, or both of the at least one module including a wheel assembly and/or the body portion; and
the at least one module including a wheel assembly and/or body portion is/are adapted to releasably connect to one or more modules, and/or one or more modular cart units and wherein interconnection between modules/modular cart units is structural.

49. The kit of parts as claimed in claim 48 which includes one or more modules.

50. The kit of parts as claimed in claim 48 wherein the further module of the modular cart unit is used as a transport box for containing the parts that are included in the kit.
